(19) United States
(12) Patent Application Publication
(10) Pub. No.: US 2015/0230390 A1
(43) Pub. Date: Aug. 20, 2015

(54) Agricultural Device

(71) Applicant: Kongskilde Industries A/S, Sorø (DK)

(72) Inventor: Ole Green, Lem St. (DK)

(21) Appl. No.: 14/422,500

(22) PCT Filed: Aug. 13, 2013
(86) PCT No.: PCT/DK2013/050262

§ 371 Date: Feb. 19, 2015

(30) Foreign Application Priority Data
Aug. 21, 2012 (DK) PA 2012 00514

(51) Int. Cl. A01B 63/24; A01B 63/00

(52) U.S. Cl. CPC A01B 63/24; A01B 63/004

(57) ABSTRACT

The invention relates to agricultural device (2) comprising a first element (1) and a plurality of second elements (6, 6′, 6″, 6″′, 6″″, 6″″′); wherein said first element has an elongated extension; wherein one or more of said second elements (6, 6′, 6″, 6″′, 6″″, 6′″″) are adapted to be movable in relation to said first element in a direction along said elongated extension of said first element; wherein each said second element comprises an agricultural activity providing system (9); wherein said agricultural device (2) comprises means for remotely and/or automatically adjusting the position of one or more of the second elements individually relative to the first element; wherein said agricultural activity providing system (9) is selected from the group comprising: seeding devices (10), weeding devices (10), fertilizing devices (10), cultivation devices (10) and tillage devices (10).

### FIELD OF INVENTION

The present invention generally relates to an agriculture device having a plurality of seeding devices, weeding devices, fertilizing devices, cultivation devices or tillage devices. The present invention more particularly relates to an agricultural device having a plurality of seeding devices, weeding devices, fertilizing devices, cultivation devices or tillage devices and means for changing the distance between the seeding devices, weeding devices, fertilizing devices, cultivation devices or tillage devices.

### PRIOR ART

Agricultural devices comprising seeding devices, weeding devices, fertilizing devices, cultivation devices or tillage devices normally comprise an elongated bar and a plurality of seeding devices, weeding devices, fertilizing devices, cultivation devices or tillage devices secured to the bar.

DE 29718303 U1 discloses an agricultural device comprising a plurality of weeding devices movable attached to a bar. The distance between the wedding devices can be changed by manually moving the weeding devices.

It is, however, very time consuming and inconvenient to adjust the distance between the weeding devices by such manual procedure. Moreover, it is only possible to achieve a limited number of distances between adjacent weeding devices due to the restrictions of the adjustment procedure.

DE 9001064 U1 discloses an apparatus for weeding of soil by cultivation. The apparatus comprises a frame which at both its sides comprises a cultivation tool. The position of the cultivation tool is adjustable in relation to the centre of the frame by means of hydraulics. The apparatus of DE 9001064 U1 does not disclose that the apparatus comprises means for individually adjusting the position of two cultivation tools. Furthermore, DE 9001064 U1 does not mention that the cultivation tools are being slidable attached to a bar or a roller chain.

This apparatus accordingly does not provide full flexibility in adjusting the cultivation tools to the row of crops that is about to be weeded.

Accordingly, there is need for an agricultural device which reduces or even eliminates the above mentioned disadvantages of the prior art.

It is an object of the present invention to provide an agricultural device that eliminates the need for moving the seeding devices, weeding devices, fertilizing devices, cultivation devices or tillage devices manually.

It is also an object of the present invention to provide an agricultural device in which the distance between adjacent weeding devices, adjacent seeding devices, adjacent fertilizing devices, adjacent cultivation devices or adjacent tillage devices can be changed steplessly.

### BRIEF DESCRIPTION OF THE PRESENT INVENTION

The present invention relates in a first aspect to an agricultural device comprising a first element and a plurality of second elements;

wherein said first element having an elongated extension;

wherein one or more of said second elements are adapted to be movable in relation to said first element in a direction along said elongated extension of said first element;

wherein each said second element comprising an agricultural activity providing system;

wherein said agricultural device comprises means for remotely and/or automatically adjusting the position of one or more of the second elements individually relative to the first element;

wherein said agricultural activity providing system being selected from the group comprising: seeding devices, weeding devices, fertilizing devices, cultivation devices and tillage devices;

characterized in that said first element comprising a bar and wherein said second elements being slidably attached to said bar; or in that said first element comprising a roller chain tightly suspended in said device and wherein said second elements being slidably attached to said roller chain.

The present invention relates in second aspect to the use of the agricultural device of the first aspect for an agricultural purpose.

The object of the present invention can be achieved by an agricultural device as defined in claim 1 and 17 respectively. Preferred embodiments are defined in the dependent sub claims and explained in the following description and illustrated in the accompanying drawings.

Accordingly, the present invention in its first and second aspect eliminates the drawbacks of the prior art set forth above.

### DESCRIPTION OF THE DRAWINGS

In the accompanying drawings:

FIG. 1 shows a schematic close-up side view of an agricultural device according to the invention;

FIG. 2 shows another side view of the agricultural device shown in FIG. 1;

FIG. 3 shows two perspective views of an agricultural device according to the invention;

FIG. 4a & FIG. 4b show two perspective close-up views of an agricultural device according to the invention;

FIG. 5a & FIG. 5b show two side views of an agricultural device according to the invention and

FIG. 6 shows a close-up side view of another agricultural device according to the invention.

FIG. 7 shows a close-up side view of an alternative agricultural device according to the invention.

FIG. 8 shows a close-up side view of yet another alternative agricultural device according to the invention.

### SUMMARY OF THE PRESENT INVENTION

The object of the present invention can be achieved by an agricultural device 2 comprising a first element 1 and a plurality of second elements 6,6′,6″,6″′,6″″,6′″″;

wherein said first element having an elongated extension;

wherein one or more of said second elements 6,6′,6″,6″′,6″″,6′″″ are adapted to be movable in relation to said first element in a direction along said elongated extension of said first element;

wherein each said second element comprising an agricultural activity providing system 9;

wherein said agricultural device 2 comprises means for remotely and/or automatically adjusting the position of one or more of the second elements individually relative to the first element;

wherein said agricultural activity providing system 9 being selected from the group comprising: seeding devices 10, weeding devices 10, fertilizing devices 10, cultivation devices 10 and tillage devices 10;

characterized in that said first element (1) comprising a bar (4) and wherein said second elements (6,6′,6″,6′″,6″″,6′″″) being slidably attached to said bar (4); or in that said first element comprising a roller chain (66) tightly suspended in said device (2) and wherein said second elements (6,6′,6″,6″′,6″″,6″″′) being slidably attached to said roller chain (66).

Hereby it is achieved that the seeding devices, weeding devices, fertilizing devices, cultivation devices or tillage devices can be moved remotely and/or automatically so that no manually adjustment is required at the site of the device. The agricultural device according to the invention is time saving and furthermore provides a more accurate adjustment of the distance between the seeding devices and/or weeding devices and/or fertilizing devices and/or cultivation devices and/or tillage devices.

It may be beneficial that the agricultural device either comprises a plurality of seeding devices or a plurality of weeding devices or a plurality of fertilizing devices or a plurality of cultivation devices or a plurality of tillage devices.

However, it is possible to have an agricultural device that comprises different types of devices (e.g. seeding devices and weeding devices).

The means for automatically adjusting the position of the seeding devices and/or weeding devices and/or fertilizing devices and/or cultivation devices and/or tillage devices relative to the first element may be any suitable means e.g. electrical means, pneumatic means or hydraulic means.

The agricultural device may comprise more than one first element. It may be an advantage that the agricultural device comprises a plurality of two or more first elements that preferably are foldably attached to each other.

The agricultural device may by way of example comprise three first elements including a centrally arranged first element that is foldably attached to two lateral first elements (one lateral first element at each end.

In one embodiment of the present invention, the first element 1 comprising a bar 4 and wherein said second elements 6,6′,6″,6″′,6″″,6″″′ being slidably attached to said bar 4.

In one embodiment of this embodiment, one or more of said second elements 6,6′,6″,6″′,6″″,6″″′ comprises a frame 8, said frame comprising a wheel 50 mechanically connected to the bar 4, wherein said wheel 50 is arranged in such a way that a rotation of the wheel 50 causes the corresponding second element to be displaced along a longitudinal direction X of the bar 4.

Hereby the wheel can be used to displace the frame along the longitudinal axis of the bar. Accordingly, the required translation of the frame can be achieved. Moreover, stepless adjustments of the distances between adjacent seeding devices and/or weeding devices and/or fertilizing devices and/or cultivation devices and/or tillage devices can be achieved.

In one embodiment of the present invention, the first element 1 in the form of said bar 4 is a toothed rack 62 and wherein said one or more of said second elements are configured to be displaced along a longitudinal axis X of said toothed rack 62.

In one embodiment of this embodiment, the one or more of said second elements 6,6′,6″,6″′,6″″,6″″′ comprises a frame 8, said frame 8 comprising a pinion 12 configured to engage with said toothed rack 62 in such a way that a rotation of the pinion 12 causes the corresponding second element to be displaced along a longitudinal direction X of said toothed rack 62.

In another embodiment of the present invention, the first element 1 in the form of said bar 4 is a holed bar 64 comprising a plurality of holes 7 arranged inline in a longitudinal direction X of said bar, and wherein one or more of said second elements are configured to be displaced along said longitudinal axis X of said holed bar 64.

In one embodiment of this embodiment, the one or more of said second elements 6,6′,6″,6″′,6″″,6″″′ comprises a frame 8, said frame 8 comprising a sprocket wheel 15 configured to engage with said holed bar 64 in such a way that a rotation of the sprocket wheel 15 causes the corresponding second element to be displaced along a longitudinal direction X of the holed bar 64.

In another embodiment of the present invention, the first element comprising a roller chain 66 tightly suspended in said device 2 and wherein said second elements 6,6′,6″,6″′,6″″,6″″′ being slidably attached to said roller chain 66.

In one embodiment of this embodiment, the one or more of said second elements 6,6′,6″,6″′,6″″,6″″′ are configured to be displaced along a longitudinal axis X of said roller chain 66.

In still one embodiment of this embodiment, the one or more of said second elements 6,6′,6″,6″′,6″″,6″″′ comprises a frame 8, said frame 8 comprising a sprocket 17 configured to engage with said roller chain 66 in such a way that a rotation of the sprocket 17 causes the corresponding second element to be displaced along a longitudinal direction X of the roller chain 66.

In the above-mentioned embodiments with the toothed rack or the holed bar or the roller chain it is achieved that the distance between adjacent seeding devices and/or weeding devices and/or fertilizing devices and/or cultivation devices and/or tillage devices can be changed steplessly. This is a huge advantage and it makes it possible to use the agricultural device in various applications.

It is preferred that the first element comprises a toothed rack or a holed bar or a roller chain and that all the adjacent seeding devices and/or weeding devices and/or fertilizing devices and/or cultivation devices and/or tillage devices are configured to be displaced along the longitudinal axis of the rack/bar/roller chain. When all the adjacent seeding devices and/or weeding devices and/or fertilizing devices and/or cultivation devices and/or tillage devices are configured to be displaced along the longitudinal axis of the bar/rack/roller chain, a very accurate adjustment of the distance between the adjacent seeding devices and/or weeding devices and/or fertilizing devices and/or cultivation devices and/or tillage devices can be achieved.

The embodiments, where the second elements comprises a frame 8, wherein said frame 8 comprising a pinion 12, a sprocket wheel 15, or a sprocket 17 configured to engage with said bar/rack/roller chain provides a very reliable and robust design which is simple to provide and operate.

By connecting driving means to the wheels and/or pinions it is possible to carry out a remote and/or an automatic and controlled rotation of the wheels and/or pinions and hereby cause a translation of the seeding devices and/or weeding devices and/or fertilizing devices and/or cultivation devices and/or tillage devices.

In one embodiment of the present invention at least some of the wheels 50 and/or pinions 12 and/or sprocket wheels 15 and/or sprockets 17 are connected to driving means 40, preferably an electrical motor 40, configured to rotate said wheels 50 and/or said pinions 12 and/or said sprocket wheels 15 and/or said sprockets 17.

The driving means may be an electrical motor, however, it would also be possible to use hydraulic driving means or pneumatic driving means to drive the wheels or the pinions.

In one embodiment of the present invention, in respect of one or more of said second elements 6,6′,6″,6″′,6″″,6″″′ a driving wheel 50 or a driving pinion 12 or a sprocket wheel 15 or a sprocket 17 is provided at a second side 54 of the first element 1 and being mechanically connected to a second side 54 of said first element 1 and that an auxiliary wheel or pinion or sprocket wheel or sprocket 14 is provided at a first side 52 of said first element 1.

Hereby it is achieved that the auxiliary wheel may be used to guide and support the translation of the frame. It is moreover possible to transfer the load of the weight of the frame and the seeding devices and/or weeding devices and/or fertilizing devices and/or cultivation devices and/or tillage devices to the auxiliary wheel so that the load on the driving pinion or the driving wheel can be reduced.

It is preferred that the first element comprises a first generally upwardly directed side, and a second opposite generally downwardly directed side.

A driving wheel or a driving pinion is preferably provided at the second side of the first element and the auxiliary wheel is preferably provide at a first side of the first element. It is preferred that the first element is sandwiched between the driving wheel or the driving pinion and the auxiliary wheel.

On the other hand it is possible that the first element comprises a first generally downwardly directed side, and a second opposite generally upwardly directed side.

In one embodiment of the present invention the agricultural device 2 comprises a control unit configured to activate the driving means 40 and hereby individually adjust the individual distance between second elements 6,6′,6″,6″′,6″″,6″″′.

Hereby the control unit may be used to carry out a controlled adjustment of the seeding devices and/or weeding devices and/or fertilizing devices and/or cultivation devices and/or tillage devices, e.g. from the inside of a vehicle so that no manual operation is required. It is also possible to use an automatic mode, in which the adjustments are carried out on the basis of predefined, measured and/or received signals.

In one embodiment of this embodiment the control unit comprises an interface, said interface being configured to be able to start, stop and change the activity of the driving means 40 and hereby individually adjust the individual distance between the second elements 6,6′,6″,6″′,6″″,6″″′.

In another embodiment of the present invention the control unit comprises an interface configured to remotely or automatically activate said agricultural activity providing system 9.

By way of example it is possible to use a smart phone as interface to control the agricultural device including activation of the means for driving the wheels or pinions or sprocket or sprocket wheels.

According to the first aspect of the present invention, it is preferred that the agricultural device 2 is a device for sowing, planting, fertilizing, weeding, cultivation or tilling.

In a second aspect, the present invention relates to a use of an agricultural device according to the first aspect for an agricultural purpose.

It is preferred that such an agricultural purpose is selected from the group comprising: sowing, planting, fertilizing, weeding, cultivation and tilling.

### DETAILED DESCRIPTION OF THE INVENTION

The invention will become more fully understood from the detailed description given herein below. The accompanying drawings are given by way of illustration only, and thus, they are not limitative of the present invention.

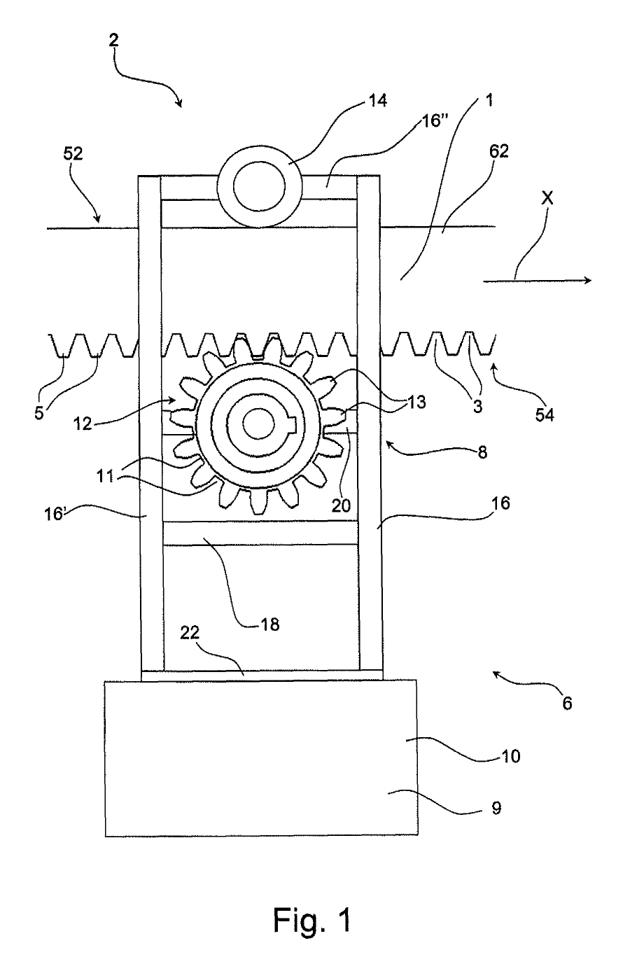

Referring now in detail to the drawings for the purpose of illustrating preferred embodiments of the present invention, an agricultural device 2 of the present invention is illustrated in FIG. 1.

FIG. 1 illustrates a schematic close-up side view of an agricultural device 2 according to the invention. The agricultural device 2 comprises a first element 1 in the form of an elongated bar 62 shaped as a toothed rack 4 having a first generally upwardly directed plane side 52 and a second opposite generally downwardly directed plane side 54.

The agricultural device 2 comprises a second element 6 comprising a frame 8 having two frame members 16, 16′ that are interconnected by a lower support member 22, two intermediate support members 20, 22 and an upper support member 16″. A pinion 12 is rotably attached to the uppermost intermediate support member 20 and the pinion 12 is engaged into the toothed rack 62.

An agricultural activity providing system 9 in the form of a device 10 is attached to the lower support member 22 of the frame 8. The device 10 is for illustrational purposes symbolized by a box, however, the device 10 may be any suitable device such as seeding devices, weeding devices, fertilizing devices, cultivation devices, tillage devices or any other suitable device.

The toothed rack 62 comprises a plurality of teeth 5 equally spaced by a corresponding number of indentations 3. The pinion 12 comprises a plurality of teeth 13 equally spaced and separated by indentations 11. The teeth 13 of the pinion 12 are configured to be received by the indentations 3 in the toothed rack 62 and the teeth 5 of the toothed rack 62 are configured to be received by the indentations 11 in the pinion 12.

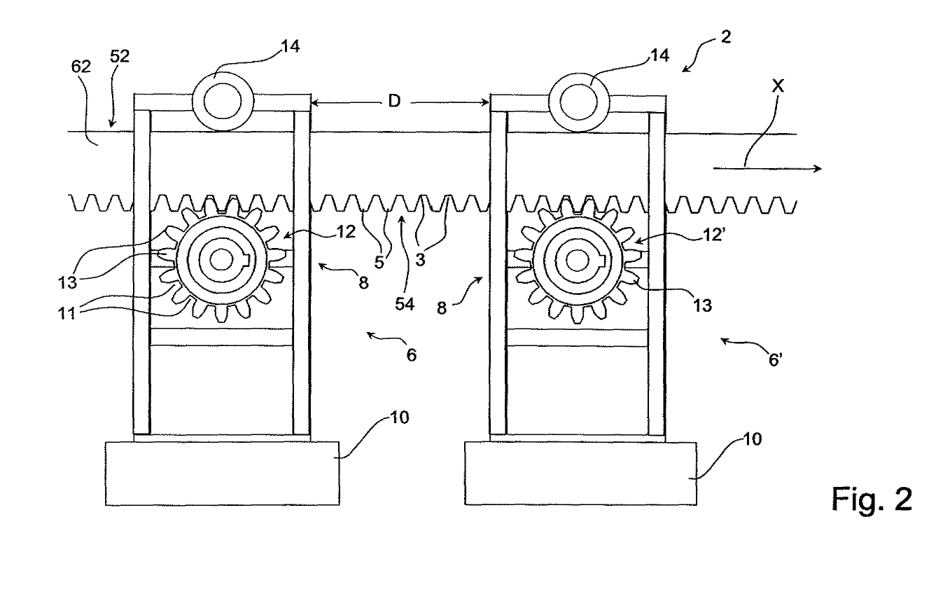

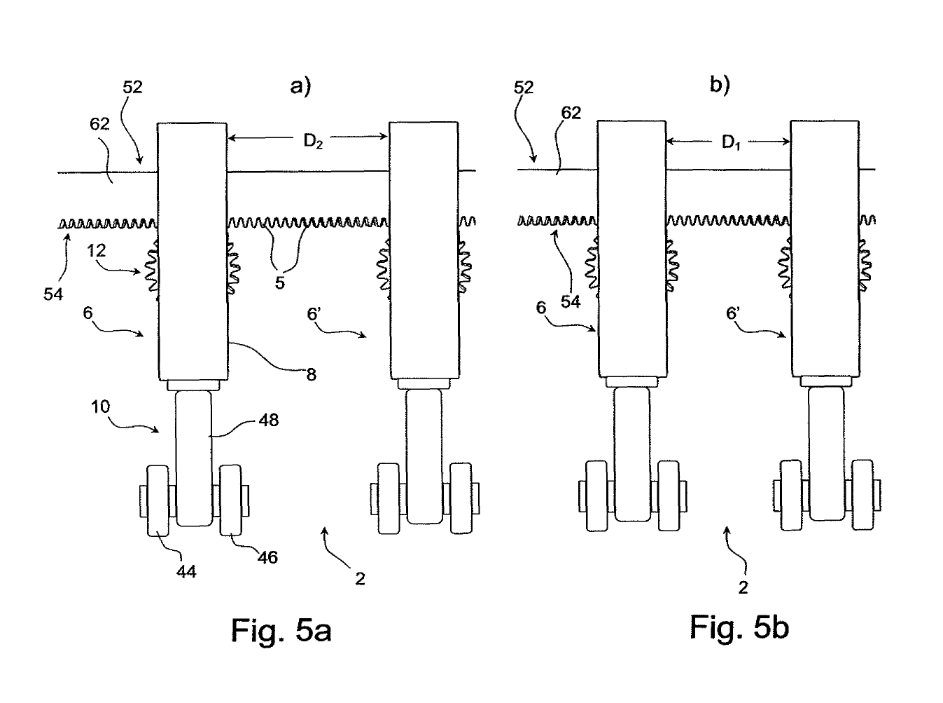

The pinion 12 is connected to driving means (not shown) configured to rotate the pinion 12 and hereby cause a translation of the second element 6 along the longitudinal axis X of the rack 62 relative to the rack 62. Hereby it is possible to change the distance between adjacent second elements 6, 6′ (see FIG. 2 or FIG. 5). The driving means may be an electric motor.

An auxiliary wheel 14 is rotably attached to the upper support member 16″. The auxiliary wheel 14 bears against the first side 52 of the rack 62 and the auxiliary wheel 14 is configured to be rotated and hereby roll along the first side 52 of the rack 62.

FIG. 2 illustrates a side view of the agricultural device 2 shown in FIG. 1. The agricultural device 2 comprises a second elements 6 and 6′. The second elements 6, 6′ are similar to the second elements shown in FIG. 1 and the members 6, 6′ are mutually spaced. The distance D between the second element 6 and the second element 6′ can be altered by rotating either the pinion 12 of the second element 6 or the pinion 12′ of the second element 6′.

When the pinions 12,12′ are being rotated in the clockwise direction the second elements 6, 6′ are moved to the left. When the pinions 12, 12′ are being rotated in the counter clockwise direction the second elements 6, 6′ are moved to the right. Of course, it is possible to move each of the second elements 6, 6′ independently in order to provide the desired distances between the members 6, 6′.

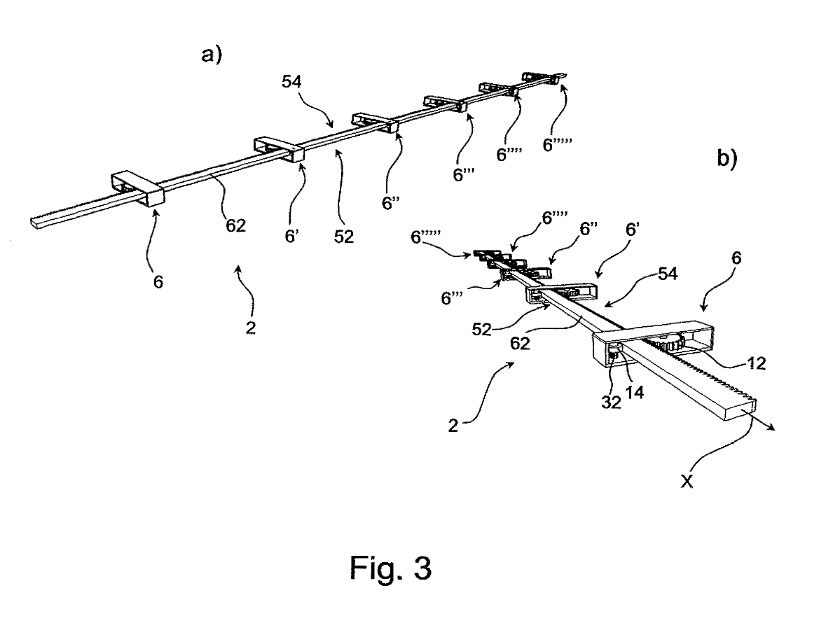

FIG. 3 illustrates two perspective views of an agricultural device 2 according to the invention. The agricultural device 2 comprises a multiple of second elements 6, 6′, 6″, 6″′, 6″″, 6″″′ arranged along a toothed rack 62. Each of the second elements 6, 6′, 6″, 6″′, 6″″, 6″″′ comprise a pinion 12 that is rotably mounted to the second element 6, 6′, 6″, 6″′, 6″″, 6″″′ and that engages the teeth 3 of the toothed rack 62.

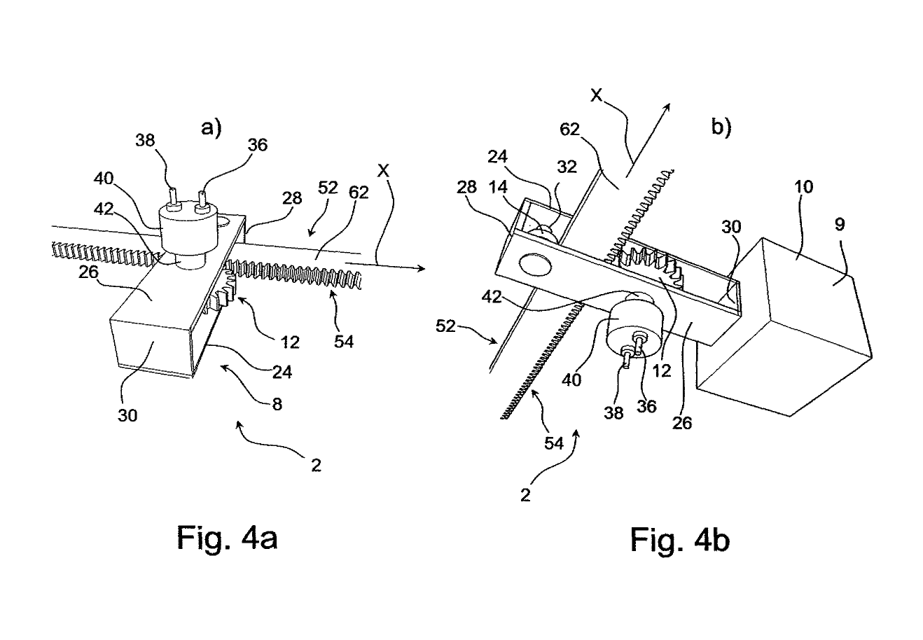

FIG. 4a illustrates a perspective close-up view of an agricultural device 2 according to the invention. The agricultural device 2 comprises a toothed rack 62 extending through the openings in a frame 8 having a plane front plate member 24, a plane back plate member 26, a plane top plate member 28 and a plane bottom plate member 30. A pinion 12 is rotably mounted to the frame 8. The pinion 12 engages the toothed rack 62 and thus the frame 8 is configured to be moved along the longitudinal axis X of the rack 62.

An electrical motor 40 is mounted to the frame 8. The motor 40 comprises a base member 42 that is mechanically connected to the back plate member 26.

The electrical motor 40 is mechanically connected to the pinion 12 and the electrical motor 40 is adapted to rotate the pinion 12 and hereby cause a translation of the frame 8 along the longitudinal axis X of the rack 62.

Two electrical cables 36, 38 are connected to the end surface of the electrical motor 40. The electrical motor 40 is powered through these electrical cables 36, 38 that preferably are connected to a control unit (not shown).

It is preferred that the agricultural device 2 comprises or is configured to be controlled by use of a centrally arranged control unit (not shown) that enables central and optionally individually control of all the second elements 6, 6′, 6″, 6″′, 6″″, 6″″′ of the agricultural device 2.

The use of an electrical motor 40 makes it possible to carry out very small adjustments of the position of the frame 8. It is, however, also possible to use the motor 40 to have a larger range of motion and thus carry out larger translation of the frame 8 along the longitudinal axis of the rack 62.

An auxiliary wheel 14 having a shaft 32 extending between the front plate member 24 and the back plate member 26 of the frame 8 is rotably mounted to the frame 8. The auxiliary wheel 14 bears against the first side 52 of the rack 62. The rack 62 is sandwiched between the auxiliary wheel 14 and the pinion 12.

In FIG. 4b an agricultural activity providing system in the form of a device 10 is attached to the bottom plate member 30. The device 10 may be a seeding device, a weeding device, a fertilizing device, a cultivation device or a tillage device by way of example. In FIG. 4b the device is illustrated as a box (for simplicity reasons). When the first side 52 of the rack 62 is oriented upwardly the weight of the frame 8 and the device 10 is transferred from the auxiliary wheel 14 to the first side 52 of the rack 62. Accordingly, the pinion 12 is not subject to load caused by the weight of the device 10 or the frame 8.

FIGS. 5a and 5b illustrate two side views of an agricultural device 2 according to the invention. The agricultural device 2 comprises a frame 8 and a bar 4 formed as a toothed rack 62 that engages the pinion 12 of two second elements 6, 6′. The rack 62 has a first side 52 and a second side 54. The teeth 5 of the rack 62 are provided at the second side 54 of the rack 62.

An agricultural activity providing system in the form of a device 10 is mechanically attached to the lower side of the frame 8. The device 10 comprises a support frame 48 and two wheels 44, 46 rotably mounted to the lower part of the support frame 48.

In FIG. 5a the distance D₂ between one second element 6 and another second element 6′ is larger than the distance D₁ between the second element 6 and the second element 6′ in FIG. 5b. The distance D₁, D₂ between one second element 6 and the other second element 6′ can be changed by rotating the pinion 12 of the second element 6 and/or the pinion 12 of the second element 6′.

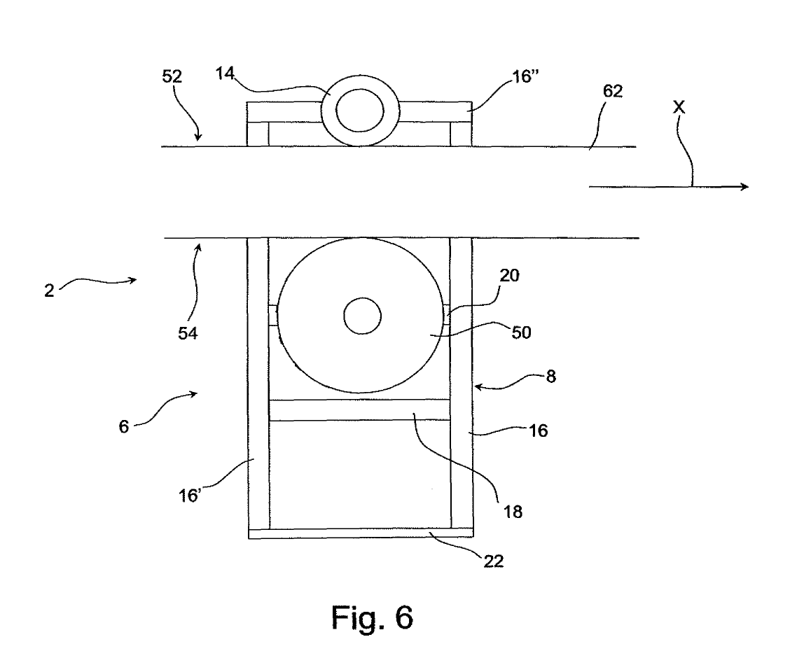

FIG. 6 illustrates a close-up side view of an agricultural device 2 according to the invention. The agricultural device 2 comprises a first element in the form of a bar 4 having a longitudinal axis X. The agricultural device 2 moreover comprises a second element 6 having a frame 8 comprising two side frame members 16, 16′, extending parallel to each other. A connection frame member 16″ connects the top portion of the two side frame members 16, 16′. A lower support member 22 connects the lower portion of the two side frame members 16, 16′. Further two intermediate support members 18, 20 connect the central region of the two side frame members 16, 16′.

An auxiliary wheel 14 is rotably mounted to the upper connection frame member 16″. The auxiliary wheel 14 bears against the first side 52 of the bar 4. A second wheel 50 is rotably attached to the central support member 20. The second wheel 50 bears against the second side 54 of the bar 4. Thus the second wheel 50 is configured to cause a translation of the second element 6 along the longitudinal axis X of the bar 4 when the second wheel 50 is rotated.

The second wheel 50 may be rotated by using any suitable means e.g. an electrical motor.

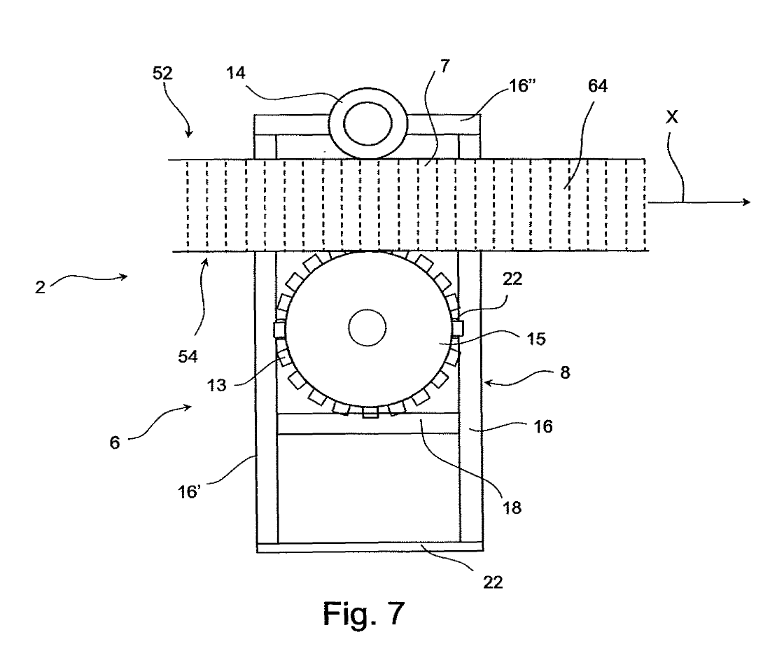

FIG. 7 illustrates a close-up side view of another agricultural device 2 according to the invention. The agricultural device 2 comprises a first element 1 in the form of a holed bar 64 having a longitudinal axis X and comprising a range of holes 7. The agricultural device 2 moreover comprises a second element 6 having a frame 8 comprising two side frame members 16, 16′, extending parallel to each other. A connection frame member 16″ connects the top portion of the two side frame members 16, 16′. A lower support member 22 connects the lower portion of the two side frame members 16, 16′. Further two intermediate support members 18, 20 connect the central region of the two side frame members 16, 16′.

An auxiliary wheel 14 is rotably mounted to the upper connection frame member 16″. The auxiliary wheel 14 bears against the first side 52 of the holed bar 64. A sprocket wheel 15 is rotably attached to the central support member 20. The sprocket wheel 15 bears against the second side 54 of the holed bar 64 in such a way that the teeth 13 of the sprocket wheel engage with the holes in the roller chain 66. Thus the sprocket wheel 15 is configured to cause a translation of the second element 6 along the longitudinal axis X of the holed bar 64 when the sprocket wheel 15 is rotated.

The sprocket wheel 15 may be rotated by using any suitable means e.g. an electrical motor.

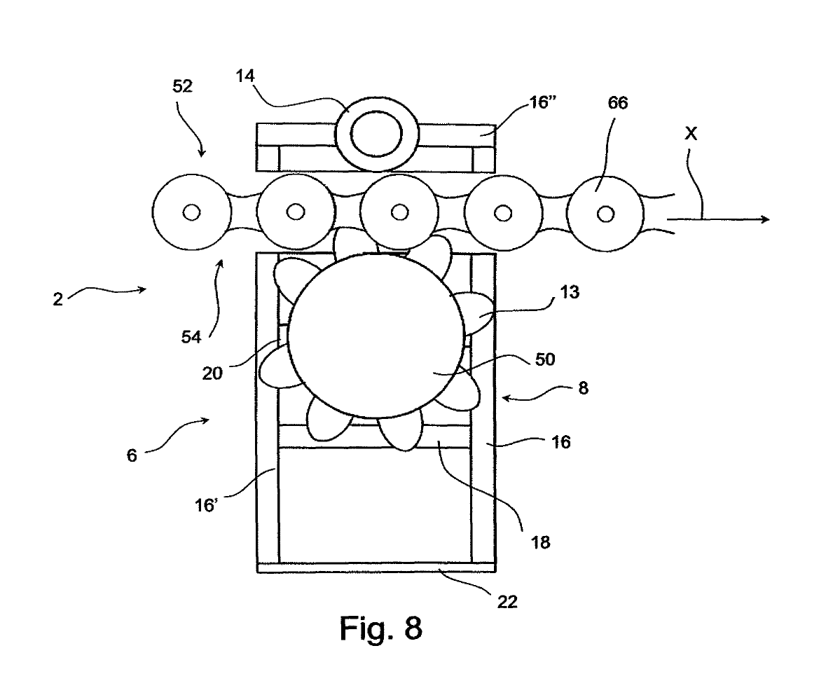

FIG. 8 illustrates a close-up side view of yet another agricultural device 2 according to the invention. The agricultural device 2 comprises a first element 1 in the form of a roller chain 66 tightly suspended in the device 2 and having a longitudinal axis X. The agricultural device 2 moreover comprises a second element 6 having a frame 8 comprising two side frame members 16, 16′, extending parallel to each other. A connection frame member 16″ connects the top portion of the two side frame members 16, 16′. A lower support member 22 connects the lower portion of the two side frame members 16, 16′. Further two intermediate support members 18, 20 connect the central region of the two side frame members 16, 16′.

An auxiliary wheel 14 is rotably mounted to the upper connection frame member 16″. The auxiliary wheel 14 bears against the first side 52 of the roller chain 66. A sprocket 17 is rotably attached to the central support member 20. The sprocket 17 bears against the second side 54 of the holed bar 64 in such a way that the teeth 13 of the sprocket engage with the “holes” or openings in the roller chain 66. Thus the sprocket 17 is configured to cause a translation of the second element 6 along the longitudinal axis X of the roller chain 66 when the sprocket 17 is rotated.

The sprocket 17 may be rotated by using any suitable means e.g. an electrical motor.

### LIST OF REFERENCE NUMERALS

1—First element
2—Agricultural device
3—Indentation
4—Bar
5—Tooth
6, 6′, 6″—Second element
6″′, 6″″, 6″″′—Second element
7—Holes
8—Frame
9—Agricultural activity providing system
10—Device
X—Longitudinal axis
D, D₁, D₂—Distance
11—Indentation
12, 12′—Pinion
13—Tooth
14—Auxiliary wheel or pinion or sprocket or sprocket wheel
15—Sprocket wheel
16, 16′, 16″—Frame member
17—Sprocket
18, 20, 22—Support member
24, 26, 28, 30—Plate member
32, 34—Shaft
36, 38—Cable
40—Motor
42—Base member
44, 46—Wheel
48—Support frame
50—Wheel
52—First side
54—Second side
62—Toothed rack
64—Holed bar
66—Roller chain

1. An agricultural device comprising a first element and a plurality of second elements;
wherein said first element has an elongated extension;
wherein one or more of said second elements are adapted to be movable in relation to said first element in a direction along said elongated extension of said first element;
wherein each said second element comprises an agricultural activity providing system;
wherein said agricultural device comprises means for remotely and/or automatically adjusting the position of one or more of the second elements individually relative to the first element;
wherein said agricultural activity providing system is selected from the group comprising: seeding devices, weeding devices, fertilizing devices, cultivation devices and tillage devices;
characterized in that said first element comprises a bar and wherein said second elements are slidably attached to said bar; or in that said first element comprises a roller chain tightly suspended in said device and wherein said second elements are slidably attached to said roller chain.

2. An agricultural device according to claim 1, wherein said first element comprises a bar and wherein said second elements are slidably attached to said bar.

3. An agricultural device according to claim 2, wherein one or more of said second elements comprises a frame, said frame comprising a wheel mechanically connected to the bar, wherein said wheel is arranged in such a way that a rotation of the wheel causes the corresponding second element to be displaced along a longitudinal direction (X) of the bar.

4. An agricultural device according to claim 2 wherein said bar is a toothed rack and wherein said one or more of said second elements are configured to be displaced along a longitudinal axis (X) of said toothed rack.

5. An agricultural device according to claim 4 wherein said one or more of said second elements comprises a frame, said frame comprising a pinion configured to engage with said toothed rack in such a way that a rotation of the pinion causes the corresponding second element to be displaced along a longitudinal direction (X) of said toothed rack.

6. An agricultural device according to claim 2, wherein said bar is a holed bar comprising a plurality of holes arranged inline in a longitudinal direction (X) of said bar, and wherein one or more of said second elements are configured to be displaced along said longitudinal axis (X) of said holed bar.

7. An agricultural device according to claim 6, wherein one or more of said second elements comprises a frame, said frame comprising a sprocket wheel configured to engage with said holed bar in such a way that a rotation of the sprocket wheel causes the corresponding second element to be displaced along a longitudinal direction (X) of the holed bar.

8. An agricultural device according to claim 1, wherein said first element comprises a roller chain tightly suspended in said device and wherein said second elements are slidably attached to said roller chain.

9. An agricultural device according to claim 8, wherein one or more of said second elements are configured to be displaced along a longitudinal axis (X) of said roller chain.

10. An agricultural device according to claim 8, wherein one or more of said second elements comprises a frame, said frame comprising a sprocket configured to engage with said roller chain in such a way that a rotation of the sprocket causes the corresponding second element to be displaced along a longitudinal direction (X) of the roller chain.

11. An agricultural device according to claim 3, wherein at least some of the wheels are connected to driving means configured to rotate said wheels.

12. An agricultural device according to claim 1, wherein in respect of one or more of said second elements a driving wheel or a driving pinion or a sprocket wheel or a sprocket is provided at a second side of the first element and is mechanically connected to a second side of said first element and an auxiliary wheel or pinion or sprocket wheel or sprocket is provided at a first side of said first element.

13. An agricultural device according to claim 11, wherein the agricultural device comprises a control unit configured to activate the driving means and thereby individually adjust the individual distance between second elements.

14. An agricultural device according to claim 13, wherein the control unit comprises an interface, said interface being configured to be able to start, stop and change the activity of the driving means and thereby individually adjust the individual distance between the second elements.

15. An agricultural device according to claim 13, wherein the control unit comprises an interface configured to remotely or automatically activate said agricultural activity providing system.

16. An agricultural device according to claim 1, wherein the agricultural device is a device for sowing, planting, fertilizing, weeding, cultivation or tilling.

17. An agricultural method comprising sowing, planting, fertilizing, weeding, cultivation or tilling using the agricultural device according to claim 1.

18. (canceled)

19. An agricultural device according to claim 5, wherein at least some of the pinions are connected to driving means configured to rotate said pinions.

20. An agricultural device according to claim 7, wherein at least some of the sprocket wheels are connected to driving means configured to rotate said sprocket wheels.

21. An agricultural device according to claim 10, wherein at least some of the sprockets are connected to driving means configured to rotate said sprockets.
